(19) United States
(12) Patent Application Publication
(10) Pub. No.: US 2009/0248200 A1
(43) Pub. Date: Oct. 1, 2009

(54) Method & apparatus for remotely operating a robotic device linked to a communications network

(75) Inventor: Timothy D. Root, Nashua, NH (US)

Correspondence Address: ROBERT SCHULER, 45 GROTON ROAD, SHIRLEY, MA, 01464, US

(73) Assignee: NORTH END TECHNOLOGIES

(21) Appl. No.: 11/975,776

(22) Filed: Oct. 22, 2007

(51) Int. Cl. G06F 19/00

(52) U.S. Cl. 700/245

(57) ABSTRACT

A remote control device able to connect to a communications network generates robot control messages are used for the remote control of a robot also able to be connected to the communications network. The remote control device creates a robot control file and an indirect reference to the robot control file which a user can select for inclusion in a robot control message. Once selected, the indirect reference to a robot control file causes the indirectly referenced robot control file to be included in a message generated by the remote control device. The remote control device establishes a communications link with the communications network, and sends the message, with the robot control file, to the robot also connected to the communications network. The robot receives the robot control message and performs at least one action according to the instruction included in the robot control message.

### FIELD OF INVENTION

My invention relates generally to the field of remote robotic control and more specifically to the field of remotely controlling the operation of a robotic device over a communications network.

### BACKGROUND OF THE INVENTION

Robotic devices are currently available that have the capability to, upon command, perform certain movements within their environment, to play and record audio or video or multimedia content from the environment in which they are positioned. Some robotic devices can be remotely controlled either directly by a remote control device proximate to the robotic device or remotely over a network to which both the robotic device and a remote control device are connected. In such a networked arrangement, both the robotic device and remote control device can be in communication with a LAN which can in turn be connected to a WAN. In the event that the robotic device and the remote control device are connected to a LAN, the connection between the robotic device and the remote control device and the LAN can be a wireless connection that employs any of the commonly known wireless communications technologies, such as technologies specified by the IEEE 802.11 standard, the Bluetooth standard or a cellular phone standard such as GSM to name only three.

As mentioned above, a remote control device can be in wired or wireless communication with a LAN and can be used to control a robotic device to move in a particular direction for some controlled period of time. A remote control arrangement for a mobile robot is described in U.S. Pat. No. 6,845,297 assigned to the IRobot Corporation. In the abstract section, in column 4 line 29 and again in column 5 line 6 is described a robot wirelessly connected to the Internet and a user interface that is remote to the robot and in communication with the robot over the Internet. The user interface device includes a “joy stick” that is used to remotely control the robots movement within its environment.

A robotic device offered by the iRobot Corporation, that is sold under the trade name “ConnectR”, can be connected to the Internet and controlled from a location that is remote to the robotic device or it can also be control locally. The robotic device includes a camera that pans and tilts, a microphone for receiving locally generated audio information and a speaker for playing remotely generated audio information. The camera pan and tilt can be controlled from the remote location so that the remote user can control the field of view. Although the robotic device control methods described above enable the robot movement and the audio and video functions to be controlled from a remote location, there is no means to coordinate the robot's movement and the audio or video functionality. Furthermore, the remote robotic device motion control mechanism only permits real-time robot control via a manual control device, such as a joy stick and the audio and video control mechanism only permits remote control over real-time audio and video signals. Real-time in this context means that the robot is not controlled using instructions contained in files that are created at some earlier time and then stored either in the robot or in the remote control device for later use.

Robotic devices are available that have the capability to play multimedia files which are received from a remote server device over a network connection. Such a capability is described in U.S. patent application assigned publication no. 2006/0161301 A1 assigned to iO.TEK Co., Ltd. The process by which the robot connects to the remote server and receives multimedia files from the server is described starting in column 2, paragraph 34. Briefly, this application describes a process whereby the robot is turned on and connects to the remote server and starts communicating with the remote server to receive multimedia files. Although the above application describes a means for coordinating the motion of a robot with a multi-media file, there is no mechanism available by which the robot can be remotely controlled. Control over the robot is a consequence of the motion instructions and multimedia information that are down-loaded to the robot from the remote server. Control with respect to which multimedia file is down loaded from the remote server to the robotic device is limited to be local to the robotic device itself.

### SUMMARY OF THE INVENTION

The object of the invention, therefore, is to provide a mechanism whereby a robotic device can be remotely controlled to move about within its environment and to play audio, video and multimedia content that is sent to the robot from a remote location or to record audio, video and multimedia content that is generated in the robots environment.

Another object of the invention is to create simple pre-programmed commands that can be selected from among a plurality of simple, pre-programmed commands which can be easily included in message that are sent over a communications network to a robot causing the robot to perform certain movements and to play or record certain audio, video and multimedia content.

It is yet a further object of the invention to provide a remote control device that is used to create and store the simple commands and to include the commands in message sent over a communications network to a robotic device linked to the communications network.

In one embodiment of the invention, a method for remotely controlling a robotic device connected to a communications network to perform at least one action is comprised of creating a robot control file and storing the file on a remote control device that is connected to a communications network; a pointer is created for each of the robot control files stored on the remote control device and the pointer is selected from a list of pointers and included in a robot control message; the robot control message, including the robot control file associated with the pointer, is sent by the remote control device over the communications network to a robot also connected to the communications network and upon receiving the robot control message the robot performs at least one action according to an instruction contained in the robotic control file.

### BRIEF DESCRIPTION OF THE DRAWINGS

FIG. 1 is a high level diagram of a representative communications network in which the invention could be implemented.

FIG. 1a is a general illustration of a robot that can be controlled by the method of the invention.

FIG. 2 is a functional block diagram of a robotic device.

FIG. 3 is a functional block diagram of a remote control device.

FIG. 4 is a diagram illustrating the general format of a robot control file.

FIG. 5a is a diagram illustrating the format of a robot control message.

FIG. 5b is a diagram illustrating the format of another robot control message.

FIGS. 6a and 6b is a logical flow diagram of the process of the invention.

### DETAILED DESCRIPTION OF THE INVENTION

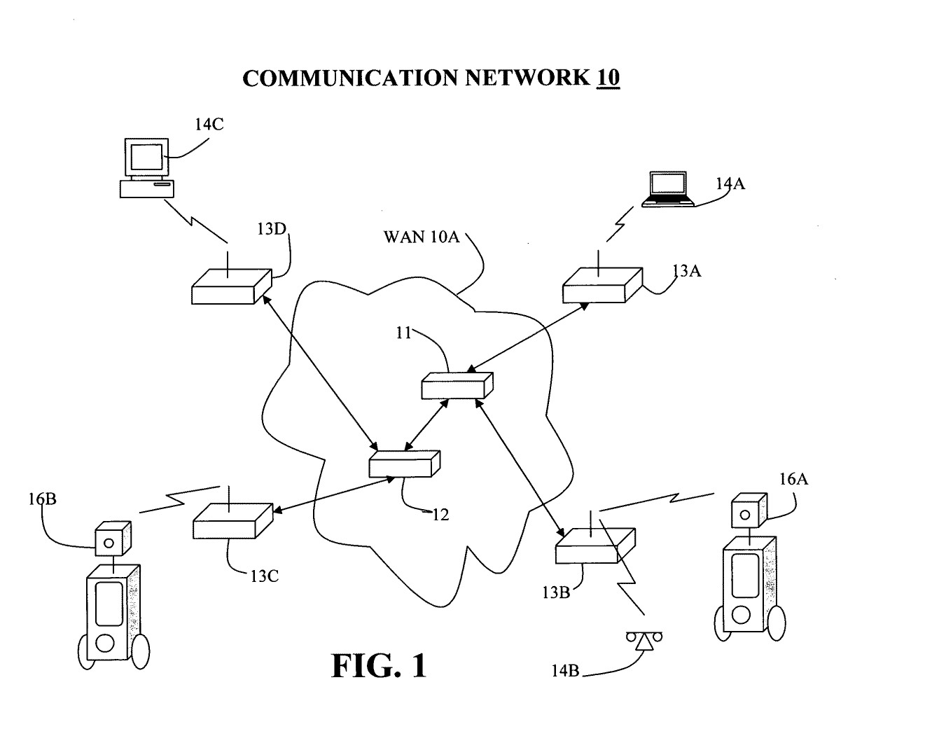

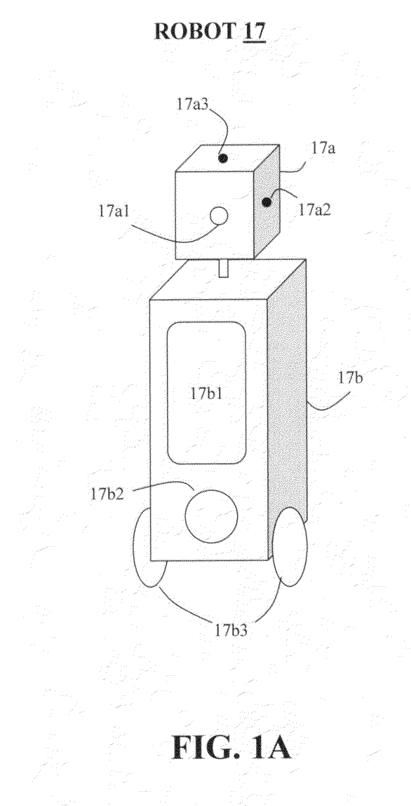

FIG. 1 is generally illustrative of the network environment in which the invention is implemented. A communications network 10 includes a WAN 10a, which for the purpose of this description can be thought of as being comprised to two network routers 11 and 12, wireless LAN routers (WR) 13a, 13b, 13c and 13d connected to the WAN 10a, remote control devices 14a, 14b, and 14c connected to the four wireless LAN routers, and robotic devices 16a and 16b connected to the wireless LAN routers 13b and 13c respectively. The WAN 10a in the preferred embodiment of the invention is the Internet, but this network can operate according to any one of a number of different wide area network communication protocols. The network routers 11 and 12 can be any type of network communications device capable of receiving packets of information, recognizing at least the destination address contained in the packet and routing or forwarding the packet further along the communications network infrastructure towards the packets destination. Only two routers are included in the WAN 10a for descriptive purposes, and there could be more or fewer routers included in the communications network.

Continuing to refer to FIG. 1, connected to the WAN 10a are a number of wireless routers 13a-13d which generally operate as the interface from the WAN and the local devices which in this case are a number of robots and remote control device used to control the robots. More specifically, the routers 13a-13d receive packets of information formatted according to the Internet Protocol and convert them to packets of information formatted, in this case according to the well known IEEE 802.11 standard protocol, and transmit the converted packets to either the remote control devices 14a-14c or to the robotic devices 16a and 16b. In the preferred embodiment of the invention, all of the routers are illustrated as being wireless, but it is not necessary for any or all of the remote control devices to be linked to a wireless router. Remote control device 14c can be a PC and be in communication with WR 13d over a wired connection, remote control device 14a can be a laptop and remote control device 14b can be a cell phone, in which case the WR 13b is a cellular access point such as a cell tower. Finally, the operation of the invention is not limited to remote control device's being linked wirelessly to any of the WR's 13a-13d but can include remote control devices connected to a network over both wired or wireless communication links.

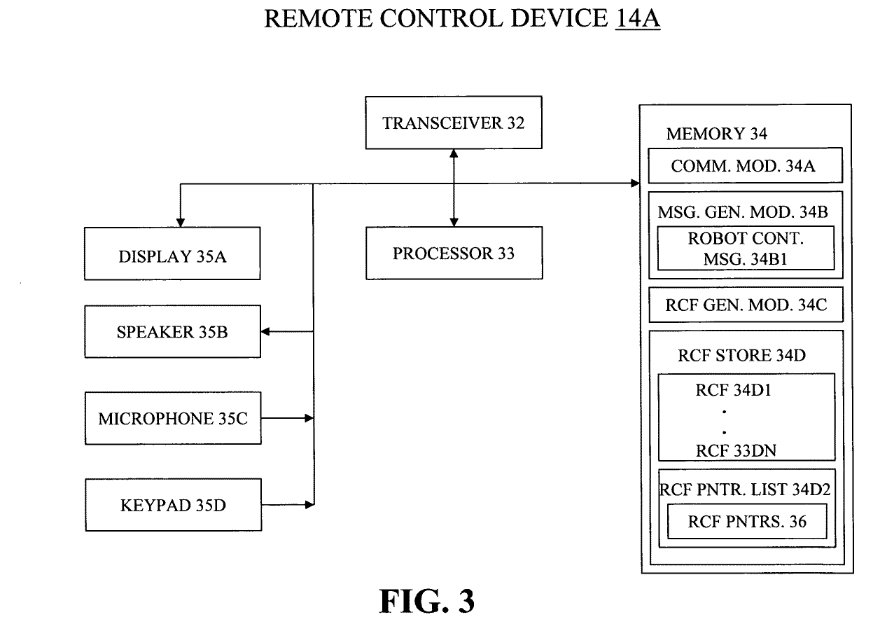

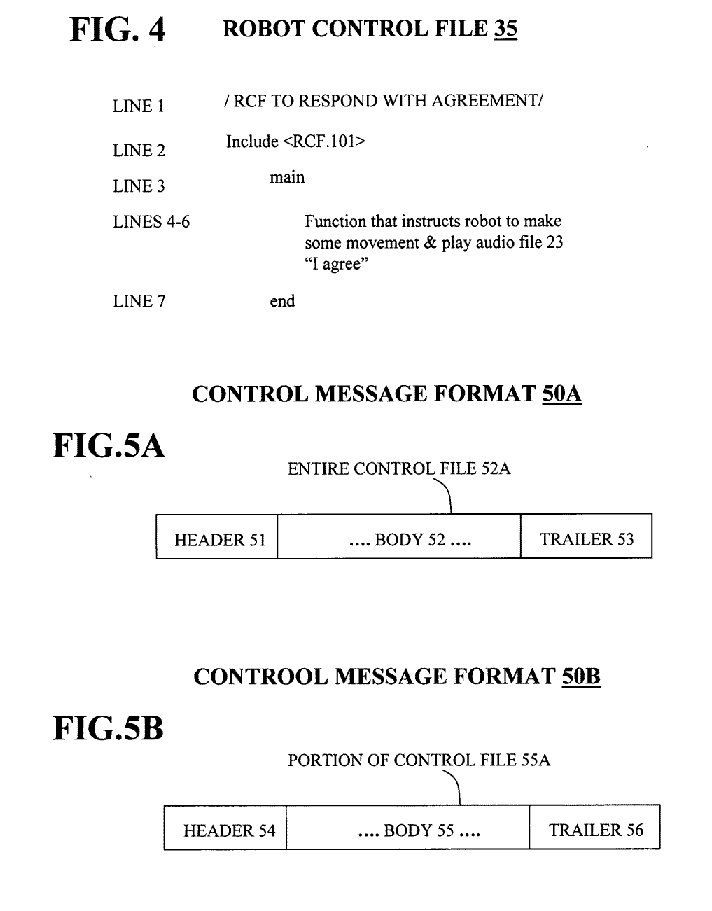

Continuing to refer to FIG. 1, and as mentioned above, the remote control devices (RCD) 14a-14c are either in wireless or wired communication with the WR's. The remote control devices function to control the operation of a robotic device either from a remote location over the Internet in this case or locally using a WR. In the later case, the RCD can be in the same room as the robotic device. In operation, an RCD is employed to remotely control the actions of a robotic device, which actions can include but are not limited to such things as movement, IR and RF transmitters, playing audio, video or multimedia content received over the communications network 10 and the operation of audio, video or other sensing or recording functionality included in the robotic device. The RCD 14a can be employed to generate and/or store robotic control files (RCF) 34d1, which will be describe later in detail with reference to FIGS. 3 and 4. Also, any of the RCDs 14a-c can generate a RCF and send it to another remote control device to be stored. A RCF 34d1 includes instructions which a robotic device can utilize to perform certain actions as mentioned above. A RCF 34d1 can be programmed in any commonly known programming language such as XML or the like and the RCD can be employed as a tool to generate such control file or the control file can be generated on another device and down-loaded onto the RCD or to a robotic device. Regardless, and according to the preferred embodiment of the invention, the RCD 14a can be used to select a RCF 34d1 and include this control file in a message sent to a robotic device, device 16b for instance, that when received by the robotic device results in the robotic device performing at least one action according to an instruction contained in the RCF 34d1.

Still continuing to refer to FIG. 1, robotic devices 16a and 16b are shown in wireless communication with WR 13b and WR 13c respectively. The robotic devices 16a and 16b can be any electro-mechanical type device that is able to wirelessly connect to a WR, WR 13c or 13b in this case, in order to communicate with other devices connected to the communications network 10. The robotic device is capable of moving around in space, either autonomously or under remote control, and it includes functionality that permits it to play audio, video and mixed media content and functionality that permits it to receive and save, among other things, audio and video information from the environment in which is resides. I will now describe the capabilities of a robotic device in greater detail with reference to FIG. 1a. Also, hereinafter, I will refer to a robotic device as simply a “robot”.

FIG. 1a generally illustrates a robot 17 that incorporates physical and mechanical characteristics included in the preferred embodiment of the invention. It should be understood that this illustration is only for the purpose of describing the functionality of a robot used to implement the method of the invention, and a robot used in conjunction with the invention need not be limited to this particular mechanical arrangement. Robot 17 includes an upper member 17a into which is incorporated at least one camera 17a1 and one or more microphones 17a2 and 17a3 strategically placed to receive audio information generated in the environment surrounding the robot. The camera operates to collect video information from the environment surrounding the robot and can be remotely controlled to pan and tilt. Alternatively, the camera may only operate to tilt and the robot can be controlled to move in such a way that the camera effectively pans through a range of view. The particular mechanisms utilized to pan and tilt the camera and the particular technologies employed to implement the microphone system are well know to those skilled in the video and audio conferencing arts and not important to the operation of the invention and so will not be described here in any detail. Robot 17 also includes a lower member 17b into which is incorporated a video display 17b1, at least one speaker 17b2 and a plurality of wheels 17b3 the rotation of each one of which can be separately and remotely controlled to cause the robot to move around in its environment. The video display 17b1 and the speaker 17b2 are employed to respectively play video and audio content sent to the robot from remote devices connected to the communications network, such as the RCD 14a of FIG. 1. Although, for the purposes of this description, I have included robot capability as described above, my invention is not limited to controlling the actions of a robot with only this set of capabilities, as other and more varied capabilities can be incorporated into a robot. For example, the robot can also include one or more lights of the same or different colors, the robot can include an IR transceiver and an RF transceiver none of which are shown in FIG. 1a.

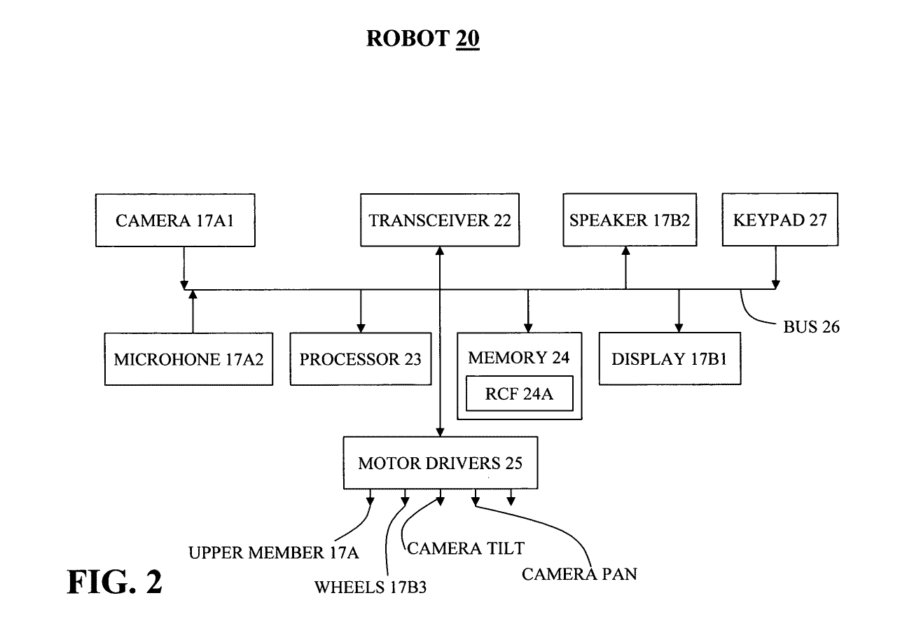

FIG. 2 is a high level diagram of a robot 20 showing the relationship between functional blocks necessary for the robots operation in conjunction with the method of the invention. Robot 20 includes an antenna 21 connected to a transceiver 22 which together function as the physical interface to a wireless medium. The transceiver receives messages from and sends messages to a WR, such as WR13c for instance, and it operates to convert the information contained in the wireless messages to information in a format that can be utilized by the processor 23 incorporated into the robot. Processor 23 generally functions to process information and instructions received in messages via the transceiver and to direct this processed information and instructions to certain robot functions, such as to the speaker 17b2 or video display 17b1 of FIG. 1. The processor 23 can also send instructions to motor drivers 25 which causes one or more of the wheels 17b3 to rotate in a particular manner or to a robot upper member to cause the camera 17a1 angle to pan or to tilt. The processor 23 may also receive messages from the transceiver or any of the robot functions with information that is stored in memory 24 for later use. Further, the processor 23 can also receive information from one or more of the microphones 17a2 incorporated into an upper member of a robot or from the camera 17a1. As described earlier, the robot can receive messages from a RCD, RCD 14a for instance, that includes one or more robot control files that can result in the robot performing a particular action, such as playing an audio file and at the same time performing some movement dictated by an instruction contained in the robot control file. In one embodiment, one or more robot control files can be stored in memory 24. The memory 24 is generally employed to store operating software that the robot uses to operate.

FIG. 3 is a functional block diagram illustrative of any one of the remote control devices (RCD) 14a-14d. For the purposes of this description I will label an illustrative remote control device “RCD 30”. RCD 30 includes an antenna 31 and a transceiver 32 to together function as the physical interface to the wireless medium. In the event that the RCD is in wired connection to the LAN, it can include a network card instead of an antenna. Regardless, the transceiver is connected to a bus 32a to which are also connect a processor 33, a memory 34 and a number of other functional elements that are typically associated with a user interface such as a display 35a, a speaker 35b, a microphone 35c and a keyboard 35d. The processor generally functions to receive information and instructions from the various user interface functions. It can combine the information and instructions received from the user interface into a robot control message that can be transmitted over the communications network 10 of FIG. 1 to a robot. The information (can be audio, video or multimedia content) and instructions mentioned above can be formatted into a software file that we referred to previously in FIG. 1 as a robotic control file (RCF) 34d1 stored in RCF store 34d in memory 34. The format of a robotic control file will be described in more detail later with reference to FIG. 4. Returning to FIG. 3, memory 34 also includes a communication module 34a for controlling access to the communications network 10, it includes a message generation module 34b for generating and formatting a robot control message 34b1 sent to a robot that include, among other things, one or more RCFs 34d1. The message generation module 34b can be an Internet compatible communications application that can be used to generate robot control messages which accommodate file attachments or indirect references/links to files stored in RCD 30 memory, for instance. The memory may also include an RCF generation module 34c that can be employed by a user to generate RCFs 34d1. The RCF generation module 34c is employed to generate RCFs 34d1 which are stored in RCF store 34d. This module can be a XML programming application or any other type of application that can be used to create the code necessary to generate an RCF 34d1. At the time the RCF 34d1 is coded, the application can also create an indirect reference to the created RCF 34d1, which will be referred to as an RCF pointer 36 that can be stored in RCF store 34d as a list 34d2 of RCF pointers 36. The listing of pointers 34d2 can be viewed on display 35a by selecting “RCF Pointers” from a menu of items. Once displayed, one or more of the pointers 36 can be selected for inclusion in a robot control message. Further, the appearance of an RCF pointer 36 as viewed in display 35a can be alphanumeric or graphical in nature. More specifically, an RCF pointer 36 can be represented as the name of a particular RCF 34d1 or it can be an icon that is in some way representative of the action a robot will perform that is associated with the particular RCF 34d1 or the RCF pointer 36 can be a combination of an RCF 34d1 file name and icon. The advantage of providing pointers 36 to RCFs 34d1 is evidenced by the ease with which a user, positioned remotely from a robot, can cause a robot to perform complex actions. It is simply necessary for a user to select one or more pointers 36 to RCFs 34d1 and include the pointers in a robot control message, which when received by a robot results in the robot performing an action or actions dictated by the instructions and information contained in the message.

In operation, the keyboard 35d or microphone 35c, if the RCD 30 is voice activated, can be employed by a user to select, from among the listing of RCF pointers 34d2, particular RCFs for incorporation into a message that can be sent, upon user command, to a robot. The RCFs can include instructions and information that cause a robot to perform a particular action or actions such as performing a particular type of movement or to play a particular audio or video or multimedia file also included in the RCF. The RCFs can also include instructions that cause a robot to coordinate or synchronize its movements with the playing of media content. For example, a remote user may wish to communicate with someone who is in the room with a robot and respond to this person by agreeing to something that was said. In this case the remote user might send a message that includes an RCF that instructs the robot to coordinate the activity that equates to the nodding of a head and playing an audio track to the effect that “yes, I agree with that”. Or, the remote user could send a message that includes information and instructions that cause the robot to play an audio file while performing dancing movements. Alternatively, a message can include a RCF that can be received and processed by multiple robots. The robots can be in the same room or not.

Referring now to FIG. 4 which is a pseudo-code example of the format that an RCF 34d1 can take. Line 1 of the pseudo-code is a comment line which indicates that the file is an RCF that can be used to send an instruction to a robot that will cause it to agree with what someone is saying. Line 2 is the first line of the program and includes the name of the file which in this case is “RCF.101”. Line 3 is the start of the main program and lines 4 to 6 includes the code that defines one or more functions which for the purpose of this description can be one or more instructions that cause a robot to perform one or more actions.

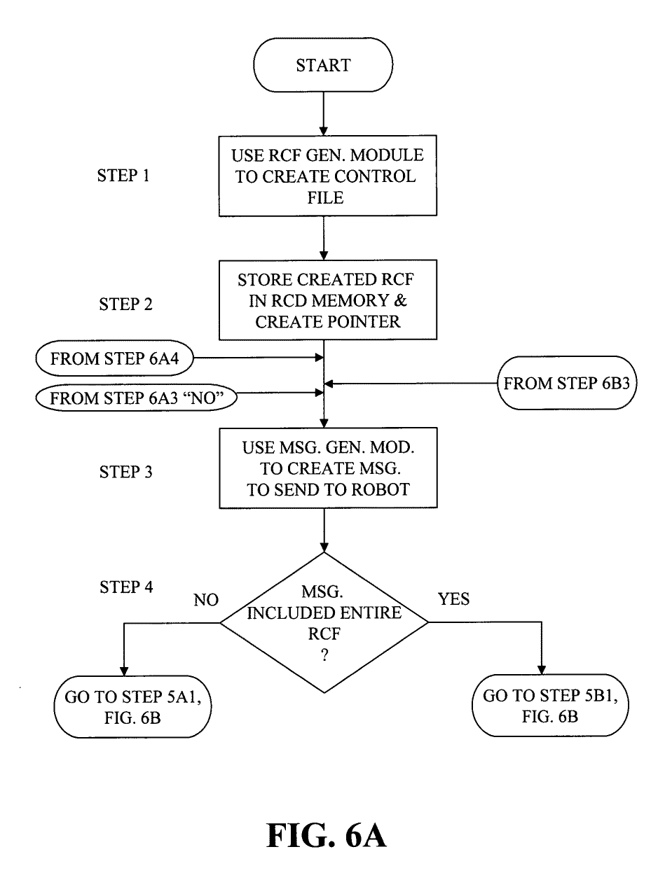

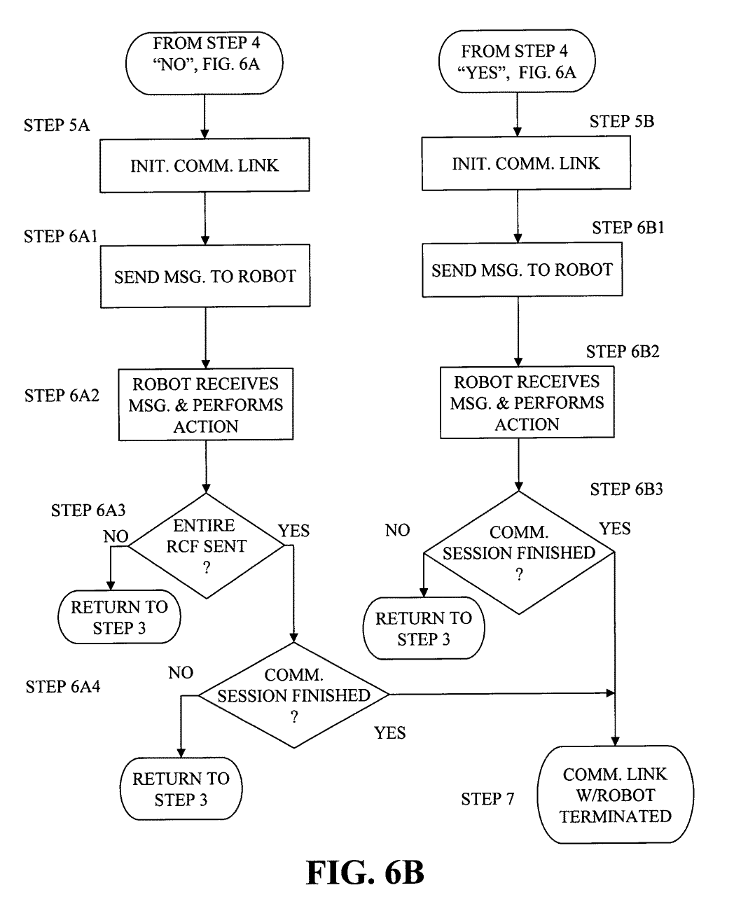

FIG. 5a is a diagram illustrating a first embodiment of the format of a message that can be sent to a robot to control its actions. The robot control message 50A includes a header section 51 a body section 52 and some sort of trailer section 53 that can be used to check whether or not the message was received by the robot. This embodiment of a robot control message includes a complete RCF which can be several thousand bits long, for instance. In the event that a particularly long RCF is selected for inclusion in a message sent to a robot, another embodiment of the control message format can be used. FIG. 5b illustrates another embodiment of a robot control message, labeled SOB, and it includes a header section 54, a body section 55 and a trailer section 56. In this case the header and trailer sections can be the same as in FIG. 5a, but the body section is different. The body section in the second embodiment includes only a portion of the entire RCF. The message generation module 34b can be designed to divide any RCF that is longer than 2K bits into equal portions, and include these RCF portions in separate and possibly sequential robot control messages. This has the effect of “streaming” portions of an RCF to a robot over time. Alternatively, the message generation module 34b can be designed to divide an RCF, regardless of its length, into unequal portions and include each portion into separate and possibly sequential messages for transmission to a robot. The way in which any particular RCF is divided, that is the length of each RCF portion, can be dictated by the instructions and information contained in the RCF. Also, as mentioned above, it may not be desirable to include a portion of an entire RCF in each message for transmission to a robot, but rather only include an RCF in selected messages. I will now describe, with reference to FIG. 6a, a process that can be employed to use the preferred embodiment of the invention to remotely control the actions of a robot.

In step 1 of FIG. 6a, RCF generation module 34b, located in memory 34 of RCD 14a, is used to create the RCF 34d1 as described in detail with reference to FIG. 3, and then in step 2, the created RCF 34d1 is stored in RCF store 34d located in memory 34. In addition to storing the RCF 34d1 in step 2, the RCF generation module 34b can be used to create a pointer 36 to RCF 14a that can be in either graphical or alpha numeric format and can be thought of as an abstract representation of one or more actions that a robot performs as a result of receiving and processing the RCF 34d1. This abstract representation allows for very efficient communication between a user and a robot and permits the user to very quickly and conveniently instruct a robot to perform very complex activities from a remote location. In step 3 of the process, the message generation module 34b can be used to create a message to send to robot, which can be robot 16a of FIG. 1 for instance. The process of creating the message is described in detail with reference to FIGS. 5a and 5b and so will not be described again here. In step 4, the message generation module 34b determines whether or not the newly created message includes an entire RCF 34d1 or if it contains only a portion of the RCF 34d1. If the newly created message contains an entire RCF 34d1, then the process proceeds to step 5b in FIG. 6b, otherwise the process proceeds to step 5a in FIG. 6b.

Proceeding to refer to FIG. 6b, if the newly created robot control message contains an entire RCF 34d1, then in step 5b a communication link is established between the robot 16a in this case and in step 6b1 the newly created robot control message is sent to the robot 16a. In step 6b2 the robot receives the robot control message and either stores the message in memory 24 as shown in FIG. 2 or the robot immediately performs the one or more actions dictated to it by the instructions in the RCF 34d1 included in the robot control message. In step 6b3 the RCD 14a determines whether the communication session is finished or not and if it is, in step 7 the communication link between the robot 16a and the RCD 14a is terminated. If the communication session is not finished, then the process returns to step 3 in FIG. 6a. If, on the other hand, in step 4 of FIG. 6a it is determined that the newly created message does not include an entire RCF 34d1, then in step 5a the RCD 14a initiates a communication link with robot 16a and, in step 6a1, sends the newly created message to the robot. The robot 16a receives the message sent to it by RCD 14a and either stores the contents of the message in memory 24 shown in FIG. 2, or it immediately performs that action or actions according to the instructions contained in the received message. As the result of receiving the instructions contained in the message, the robot 16a can move around in its environment or the robot may play audio, video or multimedia content that is contained in the same message as the instructions. Also, the instructions may result in the robot 16a coordinating its movement to the audio, video or multimedia content included in the message. In step 6a3 the RCD14a determines whether or not the entire RCF 34d1 is sent, and if it has been sent in its entirety, the process proceeds to step 6a4 where the RCD 14a determines whether or not the communication session is finished. Otherwise, the process returns to step 3 where another message is generated that contains another portion of RCF 34d1. If the communication session is finished, then the process proceeds to step 7 and the communication link between the robot 16a and the RCD 14a is terminated.

The forgoing description, for purposes of explanation, used specific nomenclature to provide a thorough understanding of the invention. However, it will be apparent to one skilled in the art that specific details are not required in order to practice the invention. Thus, the forgoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

I claim:

1. A method for remotely controlling at least one robotic device connected to a communications network to perform at least one action comprising;
creating at least one robot control file and storing the at least one robot control file on a remote control device;
creating an indirect reference to each one of the at least one stored robot control files and storing the indirect reference on the remote control device;
selecting at least one indirect reference to a robot control file stored on the remote control device and including it in a robot control message;
moving the at least one robot control file indirectly referenced into the robot control message;
the remote control device establishing a communications link over the communications network with the at least one robot and sending the robot control message including the robot control file over the communications network to the at least one robot;
the at least one robot receiving the robot control message and performing at least one action according to an instruction contained in the robotic control file.

2. The method of claim 1 wherein the at least one robot control file moved into the robot control message is a complete robot control file.

3. The method of claim 1 wherein the at least one robot control file moved into the robot control message is a portion of a complete robot control file.

4. The method of claim 1 wherein the communications network is the Internet.

5. The method of claim 1 wherein the robot control file is comprised of one or more of an instruction and media content information that are utilized by the at least one robot to perform at least one action.

6. The method of claim 5 wherein the instruction included in the robot control file is utilized by the at least one robot to perform at least one of a movement, lighting control, IR control, RF control, play media content and record media content.

7. The method of claim 1 wherein the at least one action performed by the robot is one of movement, IR control, RF control, lighting control, playing media content and recording media content.

8. The method of claim 1 wherein the remote control device is one of a PDA, a laptop computer, a cell phone and a personal computer.

9. The method of claim 1 wherein the indirect reference to a stored robot control file is a pointer.

10. The method of claim 9 wherein the pointer is observable by a user of the remote control device as an abstract representation of instructions and information included in the robot control message.

11. The method of claim 1 wherein the robot control message is comprised of at least one robot control file.

12. A method for remotely controlling at least one robotic device connected to a communications network to perform at least one action comprising;
creating at least one robot control file and storing the at least one robot control file on the at least one robotic device connected to the communications network;
creating an indirect reference to each one of the at least one stored robot control files and storing the indirect reference on the remote control device;
selecting at least one indirect reference to a robot control file stored on the remote control device and including it in a robot control message;
the remote control device establishing a communications link over the communications network with the at least one robot and sending the robot control message including the indirect reference to the robot control file over the communications network to the at least one robot;
the at least one robot receiving the robot control message, retrieving the stored robot control file indirectly referenced in the robot control message and performing at least one action according to an instruction contained in the robotic control file.

13. The method of claim 12 wherein the at least one robot control file moved into the robot control message is a complete robot control file.

14. The method of claim 12 wherein the at least one robot control file moved into the robot control message is a portion of a complete robot control file.

15. The method of claim 12 wherein the communications network is the Internet.

16. The method of claim 12 wherein the robot control file is comprised of one or more of an instruction and media content information that are utilized by the at least one robot to perform at least one action.

17. The method of claim 16 wherein the instruction included in the robot control file is utilized by the at least one robot to perform at least one of a movement, lighting control, IR control, RF control, play media content and record media content.

18. The method of claim 12 wherein the at least one action performed by the robot is one of movement, IR control, RF control, lighting control, playing media content and recording media content.

19. The method of claim 12 wherein the remote control device is one of a PDA, a laptop computer, a cell phone and a personal computer.

20. The method of claim 12 wherein the indirect reference to a stored robot control file is a pointer.

21. The method of claim 20 wherein the pointer is observable by a user of the remote control device as an abstract representation of instructions and information included in the robot control message.

22. The method of claim 12 wherein the robot control message is comprised of at least one robot control file.

23. An apparatus for remotely controlling the operation of a robotic device connected to a communications network comprising:
a transceiver;
a processor; and
a memory that includes a communications module, a robot message generation module, a robot control file generation module, a robot control file store, and a store for an indirect reference to the robot control file; wherein the robot control file generation module operates:
to create at least one robot control file and store the at least one robot control file on a remote control device;
to create an indirect reference to each one of the at least one stored robot control files and store the indirect reference on the remote control device; and
wherein the robot message generation module operates:
to select at least one indirect reference to a robot control file stored on the remote control device and include it in a robot control message; and
move the at least one robot control file indirectly referenced into the robot control message for transmission over the communications network to the robotic device which receives the robot control message and performs at least one action according to at least one instruction included in the robot control message.
